(19) United States
(12) Patent Application Publication
(10) Pub. No.: US 2015/0012400 A1
(43) Pub. Date: Jan. 8, 2015

(54) SYSTEMS AND METHODS FOR SWITCHING CREDIT CARD ACCOUNTS

(71) Applicants: Michael J. Wassmer, Richmond, VA (US); Rajsaday Dutt, Glen Allen, VA (US); Jacob George, Glen Allen, VA (US); Scott L. Zimmer, Charlotte, NC (US); Gagan Kanjlia, Ashburn, VA (US); Vishal Puri, Ashburn, VA (US); Michael B. Kiernan, Fairfax, VA (US); Jay F. Pober, Cherry Hill, NJ (US); Matthew H. Purdin, Arlington, VA (US); Rabin Bhattacharya, Kensington, MD (US)

(72) Inventors: Michael J. Wassmer, Richmond, VA (US); Rajsaday Dutt, Glen Allen, VA (US); Jacob George, Glen Allen, VA (US); Scott L. Zimmer, Charlotte, NC (US); Gagan Kanjlia, Ashburn, VA (US); Vishal Puri, Ashburn, VA (US); Michael B. Kiernan, Fairfax, VA (US); Jay F. Pober, Cherry Hill, NJ (US); Matthew H. Purdin, Arlington, VA (US); Rabin Bhattacharya, Kensington, MD (US)

(73) Assignee: CAPITAL ONE FINANCIAL CORPORATION, McLean, VA (US)

(21) Appl. No.: 14/324,899

(22) Filed: Jul. 7, 2014

Related U.S. Application Data
(63) Continuation-in-part of application No. 13/969,883, filed on Aug. 19, 2013.
Application No. 13/969,883 is a continuation-in-part of application No. 13/969,891, filed on Aug. 19, 2013.
(60) Provisional application No. 61/843,673, filed on Jul. 8, 2013.

(51) Int. Cl. G06Q 20/34

(52) U.S. Cl. CPC G06Q 20/354; G06Q 40/02
USPC 705/35

(57) ABSTRACT

Systems and methods are disclosed that provide credit card account switching processes. In certain embodiments, a card switch system is disclosed to automate or near-automate one or more processes for effectuating the switch of a credit card account from one card carrier to another. The system is configured to receive an indication to switch credit card accounts for a customer. Further, the system receives user cardholder data associated with at least one of the customer, the previous credit card account, or the new credit card account. The system is configured to identify, based on the received cardholder data, account information associated with the previous credit card account to associate with the new credit card account. Finally, the system is configured to transfer the identified account information to a system associated with the new credit card account.

### CROSS-REFERENCE TO RELATED APPLICATIONS

This application claims priority under 35 U.S.C. §119 to U.S. Provisional Application No. 61/843,673, filed on Jul. 8, 2013, and is a continuation-in-part under 35 U.S.C. §120 of U.S. application Ser. No. 13/969,883, filed Aug. 19, 2013, and a continuation-in-part under 35 U.S.C. §120 of U.S. application Ser. No. 13/969,891, filed Aug. 19, 2013, each of which is expressly incorporated herein by reference in its entirety.

### BACKGROUND

Currently, financial account providers, such as banks, credit card companies, merchants, lenders, and the like, offer disjointed mechanisms for customers to switch their financial activity from an existing provider. These mechanisms typically focus on limited aspects of the switch process, and comprise, paper-based forms, concierge-based (over the phone) services, and bill-payee information “scraping” from an existing account and assisted set-up in a new account.

Existing paper-based processes require a customer to pore over transaction statements to figure out exactly what activity should be switched over to a new account and then manually collect information for each of these accounts. In addition, existing paper-based processes also require the customer to fill out forms with information that must be provided to others to facilitate the switch, such as a Human Resources Department for Direct Deposit changes, or a biller (such as a utility company or a payment processing services provider) to change automatic ACH payments, etc.

Concierge-based switching services are no better. These services still require the customer to manually collect information and provide it to agents over the phone. The agent in turn creates the relevant forms and sends them to the relevant parties to process the switch.

Moreover, consumers are left in the dark concerning the degree of difficulty and complexity involved in switching accounts. No processes exist that give transparency to the switching process based on a customer's unique situation (e.g. how many direct deposits they have, how many bill payees they have set up in their previous account and how many bills are automatically debited from their account). Current solutions also require customers to closely manage the switch to avoid fees, overdrafts, etc. due to a lack of simple mechanisms to categorize and list activity, switch each type of activity, and track progress of the switch in a way that alleviates customer concerns.

Thus, existing mechanisms are cumbersome, slow, and lack user-friendly feedback that enable a customer to switch a financial account to a new provider offering switching incentives.

### SUMMARY

Methods, systems, and articles of manufacture described herein enable a computer system to switch a previous credit card account associated with a customer to a new credit card account for the customer. In one embodiment, a computing system may receive an indication to switch credit card accounts of the customer. Additionally, the computing system may receive user cardholder data associated with at least one of the customer, the previous credit card account, or the new credit card account. The computing system may identify, based on the received cardholder data, account information associated with the previous credit card account to associate with the new credit card account. Further, the computing system may transfer the identified account information to a system associated with the new credit card account.

In another embodiment, a non-transitory computer-readable storage medium is disclosed, containing instructions which, when executed on or by a processor, perform a method for switching a previous credit card account associated with a customer to a new credit card account for the customer. The method includes receiving an indication to switch credit card accounts of the customer. Additionally, the method includes receiving user cardholder data associated with at least one of the customer, the previous credit card account, or the new credit card account. Further, the method includes identifying, based on the received cardholder data, account information associated with the previous credit card account to associate with the new credit card account. The method also includes transferring the identified account information to a system associated with the new credit card account.

In yet another embodiment, a computer system is disclosed for switching a previous credit card account associated with a customer to a new credit card account for the customer. The computer system may receive an indication to switch credit card accounts of the customer. Additionally, the computer system may receive a request for information associated with at least one of the customer or the previous credit card account. Further, the computer system may compile the requested information. The computer system may transmit the compiled information to a computer system.

It is to be understood that both the foregoing general description and the following detailed description are exemplary and explanatory only and are not restrictive of the disclosed embodiments, as claimed.

### BRIEF DESCRIPTION OF THE DRAWINGS

The accompanying drawings, which are incorporated in and constitute a part of this specification, illustrate disclosed embodiments and, together with the description, serve to explain the disclosed embodiments. In the drawings:

FIG. 1 is a block diagram of an exemplary system, consistent with disclosed embodiments.

FIG. 2 is a block diagram of another exemplary system, consistent with disclosed embodiments.

FIG. 3 is a flowchart of an exemplary credit card account switching process, consistent with disclosed embodiments.

FIG. 4 is a flowchart of an exemplary online bill payment switching process, consistent with disclosed embodiments.

FIG. 5 is a flowchart of an exemplary transaction re-route process, consistent with disclosed embodiments.

FIG. 6 is a flowchart of an exemplary card carrier re-route process, consistent with disclosed embodiments.

FIG. 7 is a flowchart of an exemplary rewards transfer process, consistent with disclosed embodiments.

FIG. 8 is a flowchart of an exemplary alternative rewards transfer process, consistent with disclosed embodiments.

FIG. 9 is a flowchart of an exemplary dummy merchant rewards transfer process, consistent with disclosed embodiments.

FIG. 10 is a flowchart of an exemplary equivalent value rewards transfer process, consistent with disclosed embodiments.

FIG. 11 is a flowchart of an exemplary indirect rewards transfer process, consistent with disclosed embodiments.

FIG. 12 is a flowchart of an exemplary personal software update process, consistent with disclosed embodiments.

### DETAILED DESCRIPTION

Reference will now be made in detail to the disclosed embodiments, examples of which are illustrated in the accompanying drawings. Wherever convenient, the same reference numbers will be used throughout the drawings to refer to the same or like parts.

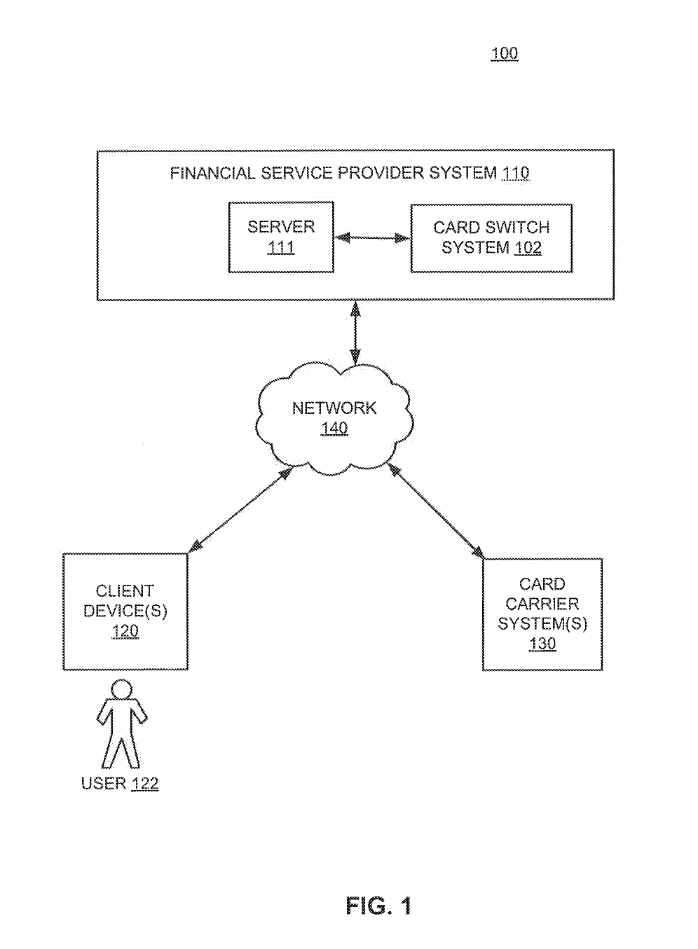

FIG. 1 shows an exemplary system that is configured to perform one or more software processes that, when executed, provide one or more aspects of the disclosed embodiments. The components and arrangement shown in FIG. 1 are not intended to be limiting to the disclosed embodiment as the components used to implement the processes and features disclosed here may vary.

In accordance with certain disclosed embodiments, a system 100 may be provided that includes a card switch system 102, financial service provider system 110, one or more client devices 120, one or more card carrier systems 130, and network 140. Other components known to one of ordinary skill in the art may be included in system 100 to process, transmit, provide, and receive information consistent with the disclosed embodiments.

Components of system 100 may be computing systems configured to provide secured mobile banking access consistent with disclosed embodiments. As used herein, “mobile” means remote. “Mobile” banking transactions may be performed on a variety of client devices, such as desktop computers, automated teller machines (ATMs), or dedicated kiosks that may or may not be actually mobile or portable. As further described herein, components of system 100 may include one or more computing devices (e.g., computer(s), server(s), etc.), memory storing data and/or software instructions (e.g., database(s), memory devices, etc.), and other known computing components. In some embodiments, the one or more computing devices are configured to execute software instructions stored on one or more memory devices to perform one or more operations consistent with the disclosed embodiments. Components of system 100 may be configured to communicate with one or more other components of system 100, including card switch system 102, financial service provider system 110, client device 120, and/or card carrier system 130. In certain aspects, users may operate one or more components of system 100 to initiate one or more operations consistent with the disclosed embodiments. In some aspects, the one or more users may be employees of, or associated with, the entity corresponding to the respective component(s) (e.g., someone authorized to use the underlying computing systems or otherwise act on behalf of the entity). In other aspects, the user may not be an employee or otherwise associated with underlying entity. In still other aspects, the user may itself be the entity associated with the respective component (e.g., user 122 operating client device 120).

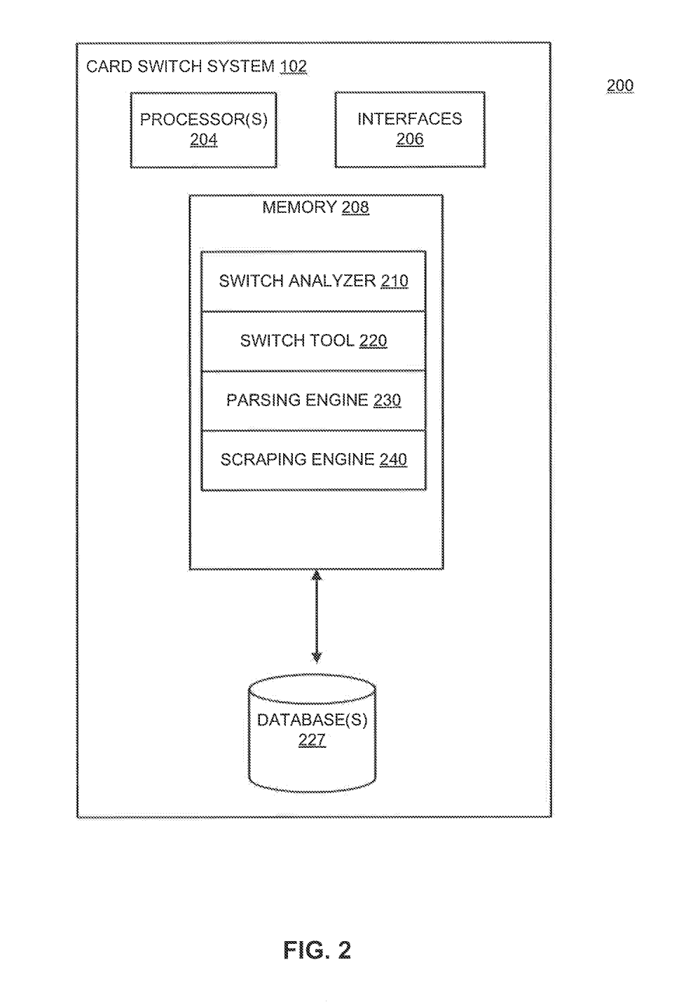

Card switch system 102 may be a computer-based system including computer system components, such as one or more servers, desktop computers, workstations, tablets, hand held computing devices, memory devices, and/or internal network(s) connecting the components. Card switch system 102 will be described in further detail in association with FIG. 2. In certain embodiments, card switch system 102 may be associated with financial service provider system 110, such as, for example, a bank, lender, merchant, credit card provider, and any other entity that provides financial accounts to customers. Financial accounts may include, for example, credit card accounts, checking accounts, savings accounts, loans, investment accounts, and any other type of account relating to financial products. In one aspect, financial service provider system 110 may be a provider that advertises, solicits, or otherwise communicates with potential customers for switching the customers' existing financial accounts to financial accounts provided by financial service provider system 110. Financial service provider system 110 may further comprise a server 111, which may communicate with, transmit data to, or store data from card switch system 102.

Client device(s) 120 may each be one or more computer systems. For example, client device 120 may include a general purpose or notebook computer, a mobile device with computing ability, a server, a desktop computer, tablet, or any combination of these computers and/or affiliated components. In one embodiment, each client may be a computer system or device that is operated by a user 122 who is a customer or a potential customer of a financial service provider, such as financial service provider system 110. Client device 120 may be configured with storage that stores one or more operating systems that perform known operating system functions when executed by one or more processors. By way of example, the operating systems may include Microsoft Windows™, Unix™, Linux™, Apple™ Computers type operating systems, Personal Digital Assistant (PDA) type operating systems, such as Microsoft CE™, or other types of operating systems. Accordingly, disclosed embodiments will operate and function with computer systems running any type of operating system. Client device 120 may also include communication software that, when executed by a processor, provides communications with network 140, such as Web browser software, tablet or smart hand held device networking software, etc. Client device 120 may be a device that executes mobile applications, such as a tablet or mobile device.

Card carrier system(s) 130 may be computing systems associated with entities that configure and provide banking services and/or information such as a brick and mortar location of a financial institution, an investment firm, a brokerage firm, or any other type of entity that provides financial and banking goods, services, and/or information that consumers (i.e., end-users or other business entities) may purchase, consume, use, etc. Card carrier system(s) 130 is not limited to systems associated with merchant(s) that conduct business in any particular industry or field. Card carrier system(s) 130 may be the same entity as financial service provider system 110, or may operate as an independent entity.

Card carrier system(s) 130 may be a bank, lender, merchant, credit card provider, or any other entity that provides credit card accounts to customers. Card carrier system 130 may also include back- and/or front-end computing components that store data and execute software instructions to perform operations consistent with disclosed embodiments, such as computers that are operated by employees of the bank (e.g., back office systems, etc.). Card carrier system 130 may also be associated with entities that provide banking and/or financial services via known online or e-commerce type of solutions. Card carrier system 130 may include server(s) that are configured to execute stored software instructions to perform operations associated with a bank, including one or more processes associated with processing financial service accounts, evaluating and issuing lines of credit, etc.

Network 140 may be any type of network configured to provide communications between components of system 100. For example, network 140 may be any type of network (including infrastructure) that provides communications, exchanges information, and/or facilitates the exchange of information, such as the Internet, a Local Area Network, or other suitable connection(s) that enables the sending and receiving of information between the components of system 100. In other embodiments, one or more components of system 100 may communicate directly through a dedicated communication link(s), such as links between card switch system 102, financial service provider system 110, client device 120, and card carrier system 130.

FIG. 2 is a block diagram of another exemplary system 200 for performing one or more operations consistent with the disclosed embodiments. System 200 is a detailed view of card switch system 102. In one embodiment, card switch system 102 may be a server that includes one or more processor(s) 204, memory devices, such as memory 208, and interface components 206. Card switch system 102 may be a single server or may be configured as a distributed computer system including multiple servers or computers that interoperate to perform one or more of the processes and functionalities associated with the disclosed embodiments. In certain embodiments, card switch system 102 may be a server that is associated with a financial account provider 110, such as, for example, a bank, lender, merchant, credit card provider, and any other entity that provides financial accounts to customers.

Processor(s) 204 may be one or more known processing devices, such as a microprocessor from the Pentium™ family manufactured by Intel™ or the Turion™ family manufactured by AMD™. Processor(s) 204 may include a single core or multiple core processor system that provides the ability to perform parallel processes simultaneously. For example, processor 204 may be a single core processor that is configured with virtual processing technologies known to those skilled in the art. In certain embodiments, processor 204 may use logical processors to simultaneously execute and control multiple processes. Processor 204 may implement virtual machine technologies, or other similar known technologies to provide the ability to execute, control, run, manipulate, store, etc. multiple software processes, applications, programs, etc. In another embodiment, processor(s) 204 may include a multiple-core processor arrangement (e.g., dual or quad core) that is configured to provide parallel processing functionalities to allow card switch system 102 to execute multiple processes simultaneously. One of ordinary skill in the art would understand that other types of processor arrangements could be implemented that provide for the capabilities disclosed herein.

Card switch system 102 may include one or more storage devices configured to store information used by processor 204 (or other components) to perform certain functions related to the disclosed embodiments. In one example, card switch system 102 may include a memory 208 that includes instructions to enable processor(s) 204 to execute one or more applications, such as server applications, network communication processes, and any other type of application or software known to be available on computer systems. Alternatively, the instructions, application programs, etc. may be stored in an external storage or available from a memory over a network. The one or more storage devices may be a volatile or non-volatile, magnetic, semiconductor, tape, optical, removable, nonremovable, or other type of storage device or tangible computer-readable medium.

In one embodiment, card switch system 102 includes a memory 208 that includes instructions that, when executed by processor(s) 204, perform one or more processes consistent with the functionalities disclosed herein. Methods, systems, and articles of manufacture consistent with disclosed embodiments are not limited to separate programs or computers configured to perform dedicated tasks. For example, card switch system 102 may include a memory that may include one or more programs to perform one or more functions of the multiple user display control features of the disclosed embodiments. Moreover, processor(s) 204 may execute one or more programs located remotely from systems 100/200. For example, system 100 may access one or more remote programs, that, when executed, perform functions related to disclosed embodiments. Memory 208 may include one or more memory devices that store data and instructions used to perform one or more features of the disclosed embodiments. Memory 208 may also include any combination of one or more databases controlled by memory controller devices (e.g., server(s), etc.) or software, such as database 227. Database 227 may comprise one or more document management systems, Microsoft SQL databases, SharePoint databases, Oracle™ databases, Sybase™ databases, or other relational databases.

Card switch system 102 may also be communicatively connected to one or more memory devices (e.g., databases (not shown)) locally or through a network. The remote memory devices may be configured to store information and may be accessed and/or managed by card switch system 102. By way of example, the remote memory devices may be document management systems, Microsoft SQL databases, SharePoint databases, Oracle™ databases, Sybase™ databases, or other relational databases. Systems and methods of disclosed embodiments, however, are not limited to separate databases or even to the use of a database.

Card switch system 102 may also include one or more I/O devices that may comprise one or more interfaces for receiving signals or input from input devices and providing signals or output to one or more output devices that allow data to be received and/or transmitted by card switch system 102. For example, card switch system 102 may include interface components 206 that may provide interfaces to one or more input devices, such as one or more keyboards, mouse devices, and the like, that enable card switch system 102 to receive data from one or more users (such as user 122 via client devices 120). Further, interface components 206 may include components configured to send and receive information between components of card switch system 102 or external to card switch system 102, such as network 140.

In certain embodiments, memory 208 may include software components that, when executed by processor(s) 204, perform one or more processes consistent with the disclosed embodiments. For example, memory 208 may include a switch analyzer 210 and switch tool 220, which include software instructions executable by one or more processors, such as processor(s) 204, alone or in various combinations. When executed, switch analyzer 210 and/or switch tool 220 may provide features relating to switching financial accounts consistent with the disclosed embodiments. Switch analyzer 210 may be configured to perform functions that provide information displayed to customers over network 140. Such information may identify and explain one or more transactions that need to be switched to a new credit card account offered by one or more of financial service provider system 110 or card carrier system 130 when the customers make the account switch. Switch analyzer 210 may also be configured to provide an automated system for customers to schedule account switches and learn of updated schedule information as the switch tool 220 performs switching processes. The logic implemented would assess the optimal schedule for minimizing the risk of incurring fees from non-sufficient funds or late bill payment. Switch tool 220 may be configured to provide tools that are used by customers over network 140 to switch activities from their previous credit card account to the new credit card account offered by financial account provider 110 or card carrier system 130, such as automatic bill pay features, reward and incentive systems, etc.

Memory 208 may also include other software processes that, when executed by processor(s) 204, perform processes consistent with the disclosed embodiments. For example, memory 208 may also include parsing engine 230 that performs parsing processes that collect and categorize raw and unformatted account data for a customer's existing credit card account. Memory 208 may also include scraping engine 240, which may be software that, when executed by processor(s) 204, seeks and collect credit card account data for a customer's existing account, such as from the customer's existing account providers computer systems.

For example, some of the processes performed by switch analyzer 210 and/or switch tool 220 include:

Demystification—this process may be performed to determine what credit card account transactions need to be switched and configured for a new account, and to generate information that is provided to the customer showing what transactions need to be switched, how those transactions can be switched, the progress of the switching of the transactions, and details relating to those transactions. This process may also determine an estimate of how much time is necessary to conduct the switch using data from customers who previously used the switching processes of the disclosed embodiments.

Switch bill pay—these processes may be performed, when executed by a processor, to automatically and/or with user input or involvement, configure bill pay and other types of financial-related activities.

Switching overall key account information—this process may be performed, when executed by a processor, to transfer, switch, and/or upload credit card account information to the new credit card account provided by financial account provider 110. For example, the process may set account preferences (e.g., starting web page when logging in, paperless statements, etc.), configure alerts (e.g., e-mail, text, phone, etc.), and store account history from the previous card carrier (e.g., statements, text files of transactions, etc.).

Progress bar—this process may be performed, when executed by a processor, to determine, monitor, and analyze the progress of a switch facilitated by card switch system 102 and generate information for display in a user-interface for presenting the progress of the switch, including, for example, a progress bar that is displayed on a user-interface. Other types of content may be implemented to reflect the progress of the switch processes, such as text, graphics, color codes, charts, percentage representations, etc.

Gamification—this process may be performed to determine and generate incentives (both virtual or real) for rewarding a customer for performing a switching-related activity such as opening a new credit card account through the disclosed embodiments, including for example reward points, interest rate adjustments, fee forgiveness, monetary credits, badges for an online profile or other virtual rewards deemed valuable, etc. Real and virtual rewards may also be given for sharing the switching experience on social networks and recommending it to other entities or users (e.g., friends, business partners, etc.).

Reminders and Alerts—this process may be performed, when executed by a processor, to determine events that should take place relating to the new financial account and determine whether certain events or issues occur that need to be addressed, and to generate appropriate alert information for display in a user-interface, communication, or the like to alert a customer of such events or issues. For example, reminders and alerts may be generated when certain stages of the switching process have been completed or when attention is needed on certain switching processes in order for a switch to be completed. Additionally, reminders and alerts may be generated around gamification elements (e.g., representations of virtual or real incentives) to encourage customers to take advantage of incentives or to let customers know when they have triggered an incentive.

Crowd sourcing and social sharing—this process may be performed to provide mechanisms that allow the customer to share their experiences relating to switching accounts via the disclosed embodiments with other individuals or entities via social networking sites. This process may be performed to collect and analyze a customer's demographics against other customer demographic information to determine and provide statistical information regarding characteristics of the customer's switch process and experience. For example, disclosed embodiments may perform processes that determine statistics of demographically similar customers to provide information to a new customer reflecting how much money similarly situated people have saved, or how long it took similarly situated people to complete an account switch using the disclosed embodiments, etc.

It is to be understood that the configuration and boundaries of the functional building blocks of systems 100 and 200 have been defined for the convenience of the description. Alternative boundaries can be defined so long as the specified functions and relationships thereof are appropriately performed. Alternatives (including equivalents, extensions, variations, deviations, etc., of those described herein) will be apparent to persons skilled in the relevant art(s). Such alternatives fall within the scope and spirit of the disclosed embodiments.

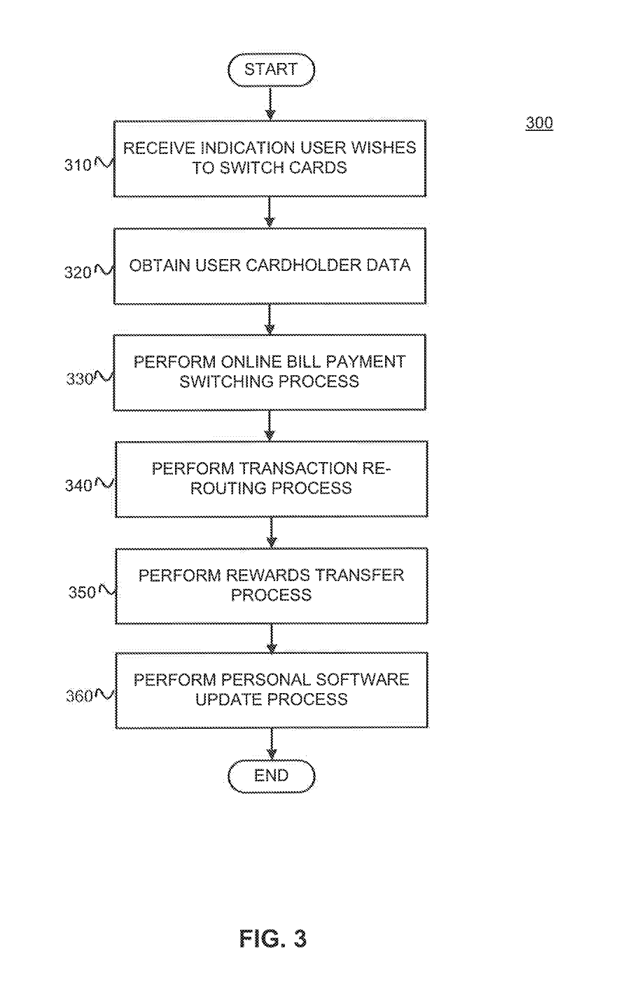

FIG. 3 shows a flowchart of an exemplary credit card account switching process 300, consistent with disclosed embodiments. In certain embodiments, card switch system 102, financial service provider system 110, client devices (e.g., devices 120), and/or card carrier system 130 may execute software instructions to perform one or more aspects of the credit card account switching process of FIG. 3. As an example, FIG. 3 is disclosed in connection with card switch system 102. FIG. 3 will be described in connection with financial service provider system 110 as the financial service account provider, but it is understood that other components may provide an account to user 122, such as card carrier systems 130.

In one aspect, card switch system 102 may receive an indication that user 122 wishes to switch from one credit card account (hereinafter, the “previous” account) to another (hereinafter, the “new” account) (Step 310). In disclosed embodiments, card switch system 102 may collect user cardholder data as part of the switch process (Step 320). The user cardholder data may include the identity of the card account provider, the identity of an account (e.g., account number(s), etc.), the identity of other accounts (e.g., one or more financial accounts may be associated with the user), and/or credentials that enable card switch system 102 to access, receive, and/or store information relating to the user's account. In some embodiments, the credentials may include biometric or other physical characteristics provided by the user to access the account. In other embodiments, the credentials may include physical devices required for access, such as a key, dongle, card, or other such device. In one embodiment, card switch processes may include collecting user cardholder data through, for example, fetching data using a customer's provided credentials or technologies that provide account scraping (e.g., collecting information about a customer's existing account), such as through scraping engine 240. In some embodiments, scraping engine 240 may capture user cardholder data from an existing account associated with the user within personal financial management software or data associated with another system or application, such as stand-alone software applications like Quicken® and/or web applets like Mint®. The switch processes may also include parsing the collected data, via parsing engine 230. For example, in one embodiment, parsing engine 230, when executed by one or more processors 204, may take user cardholder data in a raw, unclassified format as it exists or is collected from the customer's previous account provider. For example, a customer's account statement may be provided in an unclassified and raw format, or the electronic data representing the customer's previous account may be formatted in raw text file format.

Parsing engine 230 may further convert the user cardholder data into categories that are used to perform the switch analysis of the disclosed embodiments. In certain embodiments, parsing engine 230 may convert the collected user cardholder data into the following categories:
Interest Paid
Monthly cycle/account fee
Over Credit Limit Fee (original/first)
Over Credit Limit Fee (subsequent/pile-on)
Cash Advance Fee (ATM owner)
Cash Advance Fee (Card carrier)
Number or frequency of account payments made
   In other embodiments, parsing engine 230 may also convert the collected user cardholder data into the following categories for use by switch analyzer 210:
Outstanding transaction information
Bill pay information
Rewards information
Classifications of transactions, such as custom classifications created by the user (type of payment, certain vendors, etc.), or transactions classified by which one of a plurality of cardholders on the account made certain transactions.

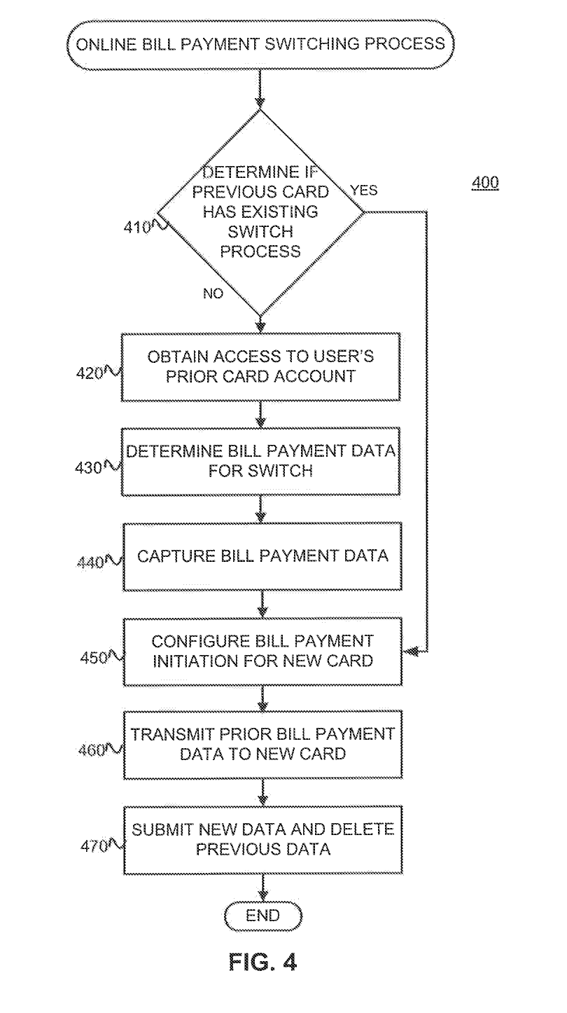

Card switch system 102 may perform an online bill payment switching process, such as is disclosed below in connection with FIG. 4 (Step 330). In brief, according to some embodiments, card switch system 102 may determine bill payment data for switching from the previous card account to the new card account. After capturing the bill payment data from the previous account, card switch system 102 may configure bill payment initiation for the new card account, transmit the captured data, and delete the old account data.

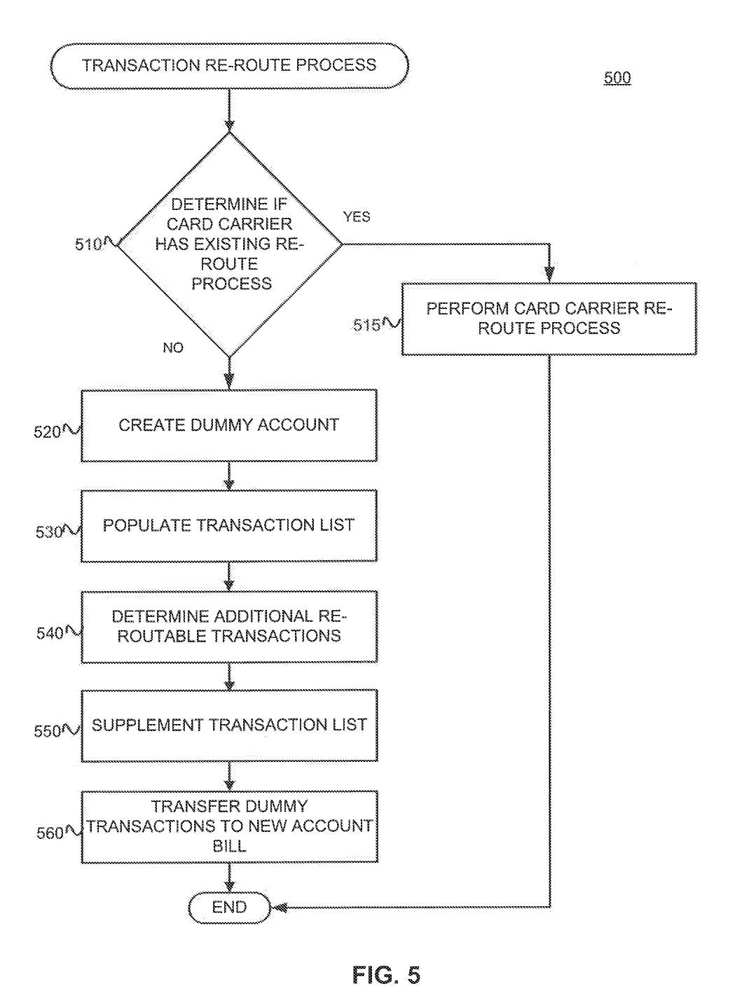

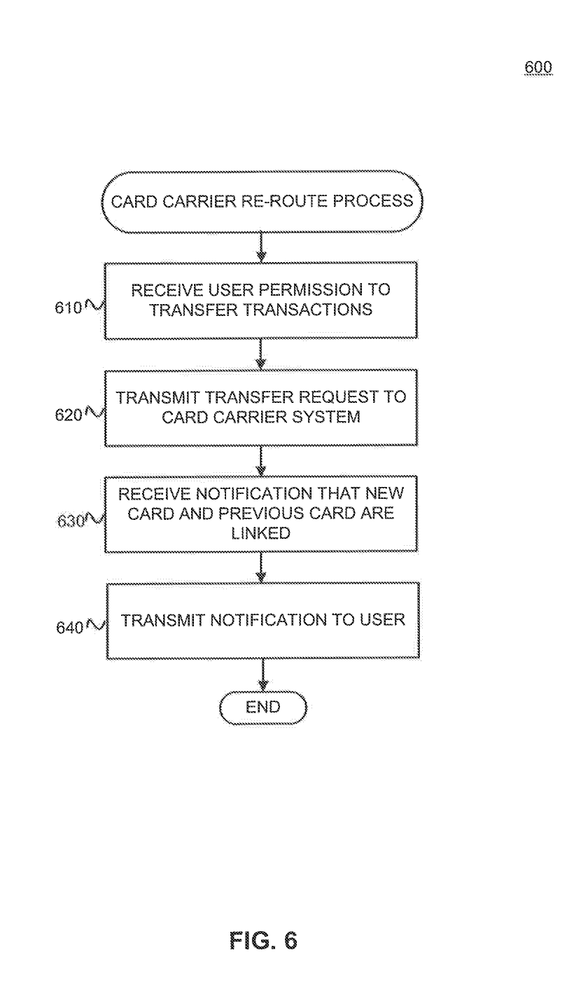

Next, card switch system 102 may perform a transaction re-routing process, such as is disclosed below in connection with FIGS. 5-6 (Step 340). In brief, according to some embodiments, card switch system 102 may re-route outstanding transactions from the previous card account and/or transactions on the previous card account that occur while the switch process is underway.

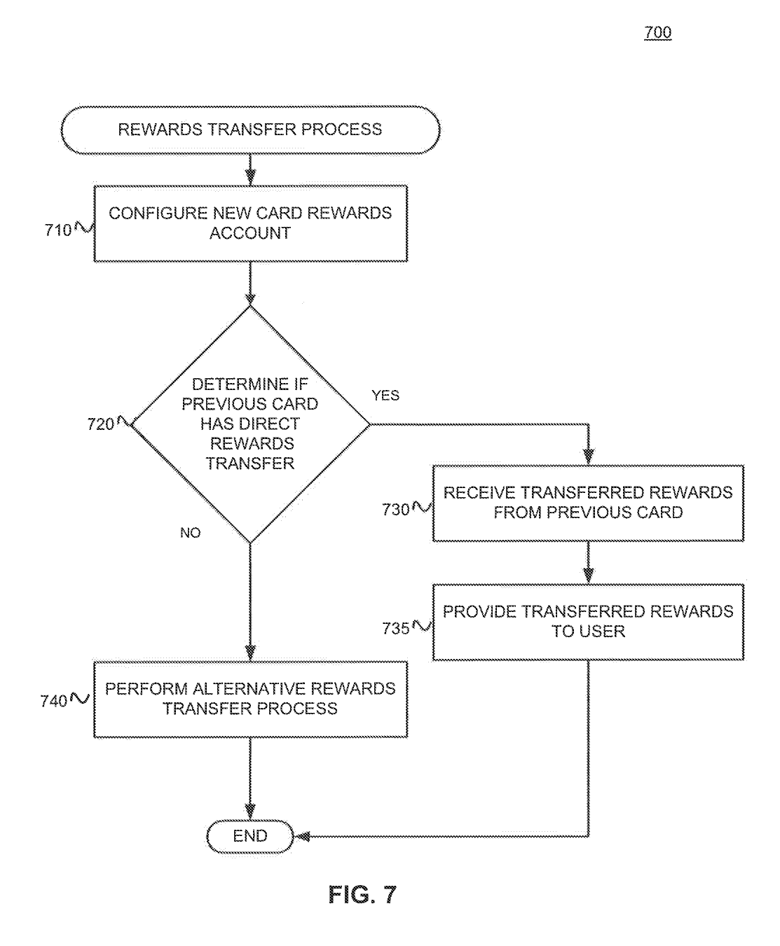

At Step 350, card switch system 102 may perform a rewards transfer process, such as is disclosed below in connection with FIGS. 7-11. In brief, according to some embodiments, card switch system 102 may determine whether the previous card account has a direct method for transferring rewards or incentives to a new account. If not, card switch system 102 may undertake one of several alternative processes to switch the user's accumulated rewards to the new card, providing motivation to switch because those already “paid for” rewards points are kept.

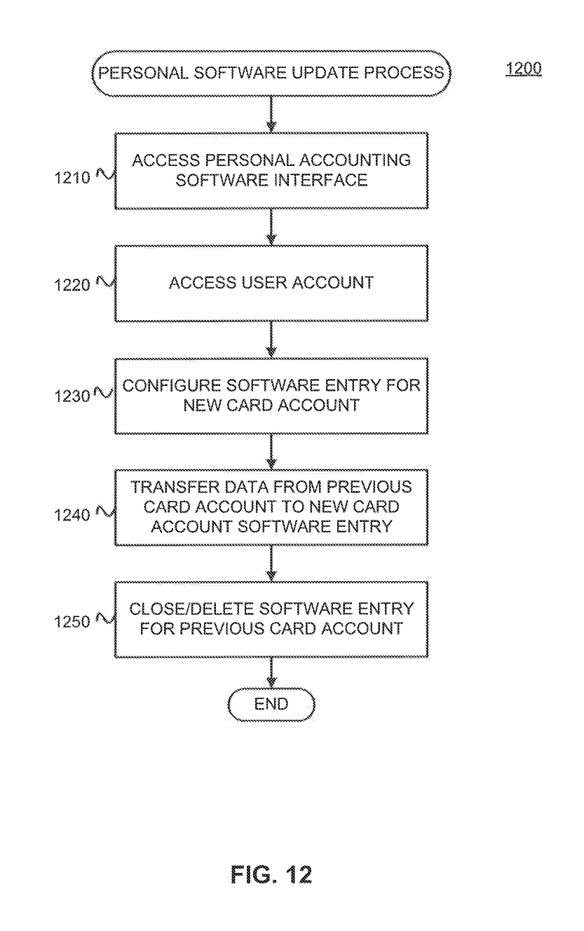

Card switch system 102 may perform a personal software update process (Step 360), such as is disclosed below in connection with FIG. 12. In brief, card switch system 102 accesses the user's personal accounting software, such as stand-alone programs like Quicken® and/or web applets like Mint®. Card switch system 102 may create and/or configure the proper software entries for the new card account, and delete relevant software entries for the previous account. Steps 330-360 are presented as examples in FIG. 3. The steps may be performed in any sequence, or even simultaneously. In some embodiments, card switch system 102 may perform process 300 for more than one previous account associated with the user at the same time. The multiple previous accounts may be consolidated into a single new account, or card switch system 102 may configure multiple new accounts for the user.

FIG. 4 shows a flowchart of an exemplary online bill payment switch process 400, consistent with disclosed embodiments and Step 330 of credit card account switching process 300, as illustrated in FIG. 3. In certain embodiments, card switch system 102, financial service provider system 110, client devices 120, and/or card carrier system 130 may execute software instructions to perform the online bill payment switch process of FIG. 4. As an example, FIG. 4 is disclosed in connection with card switch system 102.

At Step 410, card switch system 102 may determine if the user's previous card carrier (e.g., card carrier system 130) has an existing process for switching automatic, recurring payments (“online bill payments”) from one credit card to another. If such a process exists (Step 410: YES), then the process proceeds to Step 450. If no such process exists (Step 410: NO), then the process proceeds on to the next step, Step 420.

Card switch system 102 may obtain access to the user's previous card account (Step 420). For example, the system may receive login credentials for an online account access system associated with the previous card carrier system, such as card carrier system 130, during the user cardholder data step of process 300, described above.

Card switch system 102 may determine online bill payment data to be switched (Step 430). The determination may be made using switch analyzer 210, switch tool 220, and parsing engine 230. For example, in some embodiments, switch analyzer 210 or parsing engine 230 may be configured, when executed by processor 204, to parse the user's previous transaction history to look for recurring transactions to the same merchant, for the same amount, and/or executed on the same day of the month. Card switch system 102 may prompt the user via network 140 to review and approve the determined online bill payment data.

Card switch system 102 may capture the online bill payment data determined to be part of the switch (Step 440). The capturing step may be performed automatically, such as via scraping engine 240. In other embodiments, the capture may be performed manually, or in an assisted manner, where the user may be prompted to indicate whether a given online bill payment transaction should be switched to the new account.

At Step 450, card switch system 102 may configure bill payment initiation for the new card account. If the new card account has an online interface via network 140, for example, card switch system 102 may submit login credentials supplied previously by the user, may prompt the user to create such login credentials for the first time, or may automatically set up a preliminary set of such login credentials. In alternative embodiments, the configuration may be performed internally within server 111, memory 208, database 227, or other devices and components associated with systems 100 and 200.

Card switch system 102 may transmit the captured online bill payment data to the new card account (Step 460). Card switch system 102 may employ switch tool 220 to transmit the data over network 140, or may use any other method for providing the data to the new card account system.

Additionally, card switch system 102 may submit the new data and delete the previous data to close out the bill payment switching process (Step 470). Switch tool 220 may automatically terminate, close, or otherwise delete the relevant database entries or other software code associated with the previous card account within card carrier system 130 that are associated with the recurring online bill payment transactions associated with the switch. This closing process saves time for the user and provides incentive to switch to a new card account by reducing “backtracking” that must be tediously performed on previous accounts.

In alternative embodiments, automatic bill payment may have previously been configured by a merchant rather than by the user in association with card carrier system 130. In such scenarios, switch analyzer 210 may analyze data parsed by parsing engine 230. Switch analyzer 210 may determine whether transactions associated with the previous card account appear to be occurring periodically, such as monthly, quarterly, yearly, etc. Card switch system 102 may then prompt user 122 to check whether merchant-initiated bill payment has been instituted.

If merchant-initiated bill payment is in effect for a given transaction or series of transactions, card switch system 102 may provide instructions to user 122 through client device 120 to facilitate switching of these transactions to the new card account. Card switch system 102 may remind user 122 to switch these transactions at regular intervals subsequent to commencement of the switching process.

In alternative embodiments, card switch system 102 may determine contact information for the merchants associated with the merchant-initiated bill payment transactions. Card switch system 102 may automatically contact the merchants on behalf of user 122 and request that the recurring automatic bill payments be switched from the previous card account to the new card account. Alternatively, card switch system 102 and switch tool 220 may effect the transfer through an online portal associated with the merchant.

FIG. 5 shows a flowchart of an exemplary transaction re-route process 500, consistent with disclosed embodiments and with Step 340 of credit card account switching process 300 as illustrated in FIG. 3. In certain embodiments, card switch system 102, financial service provider system 110, client devices 120, and/or card carrier system 130 may execute software instructions to perform the transaction re-route process of FIG. 5. As an example, FIG. 5 is disclosed in connection with card switch system 102.

At Step 510, card switch system 102 determines if the previous card carrier, such as card carrier system 130, has an existing process for existing process for re-routing certain transactions from one credit card to another. If such a process exists (Step 510: YES), then the process proceeds to Step 515 and card switch system 102 may perform a card carrier re-route process, such as that disclosed below in association with FIG. 6. If no such process exists (Step 510: NO), then the process proceeds on to the next step, Step 520.

User 122 may desire to “re-route” a number of transactions from the previous card account to the new card account. Examples of such transactions may include, but are not limited to, transactions paid for with the previous card past a certain date, transactions placed on the previous card account after the switch process began, and/or recurring transactions not covered by online bill payment switching process 400. To assist with re-routing these transactions, card switch system 102 may create a so-called “dummy,” or “false” account (Step 520). Card switch tool 102 may configure the dummy account in a variety of ways to serve the needs of the user. Transactions paid for with the previous card account may thus automatically transfer to the new account seamlessly with no extra steps taken manually by the user. The dummy account may “pay” for the transactions directly to the previous card carrier, such as card carrier system 130. Card switch system 102 may populate a list of such transactions over set periods of time that are associated with the dummy account (and therefore, the previous card account) (Step 530). The list population may be achieved periodically on an automatic basis, for example, by using scraping engine 240. In some embodiments, at predetermined time intervals, scraping engine 240 may access the previous card account over network 140 through card carrier system 130, and scrape all transactions outstanding from the previous card account. In alternative embodiments, switch tool 102 may utilize scraping engine 240 one time, such as at the end of a billing cycle. Various methods for populating a list of re-routable transactions may be contemplated by those skilled in the art.

Card switch system 102 may determine additional transactions to add to the re-routable transaction list (Step 540), and thereafter supplement the list based on the determination (Step 550). In some embodiments, card switch system 102 may determine transactions that were made without the card being present, and may further determine that all such transactions should be re-routed, In other embodiments, card switch system 102 may determine transactions that were made with the card present, and may prompt user 122, through client device 120, to determine and/or confirm whether such transactions should be re-routed to the new account. In some embodiments, card switch system 102 may further prompt user 122, through client device 120, to determine and/or confirm whether or not necessary re-routable transactions have been accounted for. The prompting may occur at predetermined time intervals, or may occur a single time. Various methods for supplementing the list of re-routable transactions may be contemplated by those skilled in the art.

Card switch system 102, using switch tool 220, may transfer the re-routable transactions from the list associated with the dummy account to the new card account (Step 560). In some embodiments, switch tool 220 may transfer the transactions to the new card account, prompt the user for payment, and transmit the payment to previous card carrier systems, such as card carrier system 130. In other embodiments, card switch system 102 may pay card carrier system 130 on the user's behalf for the dummy transactions, then notify the user that payment is due to the new account. In other embodiments, card switch system 102 and/or card carrier system 130 may direct the user to pay a bill or payment associated with the previous card account. Subsequently, card switch system 102 may provide the user with a statement credit, reward, or other equivalent value on the new card account.

FIG. 6 shows a flowchart of an exemplary card carrier re-route process 600, consistent with disclosed embodiments, Step 515 of transaction re-route process 500, and with Step 340 of credit card account switching process 300 as illustrated in FIG. 3. In certain embodiments, card switch system 102, financial service provider system 110, client devices 120, and/or card carrier system 130 may execute software instructions to perform the card carrier re-route process of FIG. 6. As an example, FIG. 6 is disclosed in connection with card switch system 102.

Card switch system 102 may receive a notification from user 122, via client device 120, that the user has granted permission to transfer certain transactions (Step 610). The permissive notification may be received via network 140, via telephonic means, via email, via text or SMS message, or by any other known means of communication.

Card switch system 102, via switch tool 220, may transmit a transfer request to the card carrier system associated with the previous card account, such as card carrier system 130 (Step 620). The request may be transmitted via network 140, or via other known means of communication.

In some embodiments, the transfer request may contain instructions to a third party entity that re-routes the transactions from the previous card account to the new card account. The third party entity may be associated or affiliated with financial service system 110 or card carrier system 130, or it may be an independent entity. The third party entity may include alternative payment platforms, such as PayPal®, or merchant service systems like Square® or Intuit®. The instructions may comprise, as a non-limiting example, certain user cardholder data (such as the new and previous card account numbers), a list of re-routable transactions, customer authorization information, and directions to patch the re-routable transactions from card carrier system 130 to financial service account system 110 by associating the previous account identification information with the new account identification information. Card switch system 102, through switch analyzer 210, may determine a plurality of third party entities to which to send instructions based on circumstances associated with the previous account to be switched. In some embodiments, third party entities may be prioritized for contact based on predetermined criteria such as reliability, cost of contact, or other factors.

Card switch system 102 may receive a notification that the previous card account and the new card account are linked (Step 630). In some embodiments, the notification may be received over network 140. In some embodiments, the notification may be received from card carrier system 130. In other embodiments, the notification may be received from another component of system 100, such as another constituent element of financial service provider system 110. In other embodiments, the notification may come directly from user 122 via client device 120. Once the previous card account and the new card account are successfully linked and transactions re-routed, card switch system 102 may transmit a notification to user 122 informing them of the successful re-routing request (Step 640). In some embodiments, the notification may be sent via network 140. The notification may be sent by any known means of communication, such as email, telephonic means, or a text or SMS message.

FIG. 7 shows a flowchart of an exemplary rewards transfer process 700, consistent with disclosed embodiments, and with Step 350 of credit card account switching process 300 as illustrated in FIG. 3. In certain embodiments, card switch system 102, financial service provider system 110, client devices 120, and/or card carrier system 130 may execute software instructions to perform the rewards transfer process of FIG. 7. As an example, FIG. 7 is disclosed in connection with card switch system 102.

Card switch system 102 may configure a rewards account for user 122 associated with the new credit card account (Step 710). In some embodiments, the rewards account may be a new account opened and configured for the first time. In other embodiments, the rewards account may be associated with a past rewards account previously configured for the user. The rewards account associated with the new credit card account may be configured by switch tool 220, and the configuration may occur at the time the new credit card account is opened. In other embodiments, the new rewards account may be configured at any time after the new credit card is opened and the switch process begins.

Via switch analyzer 210, card switch system 102 may determine whether the card carrier associated with the previous credit card account (for example, card carrier system 130) has an existing process for directly transferring rewards from one card carrier to another (Step 720). If such a process does exist (Step 720: YES), the process proceeds to Step 730.

At Step 730, card switch system 102 may receive the transferred rewards from card carrier system 130. In some embodiments, card switch system 102 may receive the rewards in the form of a cash or equivalent payment from card carrier system 130. In other embodiments, the rewards may have no equivalent cash value, and the value is simply stored in memory 208, database 227, or any other such suitable storage media associated with the new credit card account and financial service provider system 110. Card switch system 102 may provide access to the transferred rewards to the user once the direct transfer process is complete (Step 735). Card switch system 102, via switch tool 220, may send a notification to user 122 via network 140 that the rewards are available.

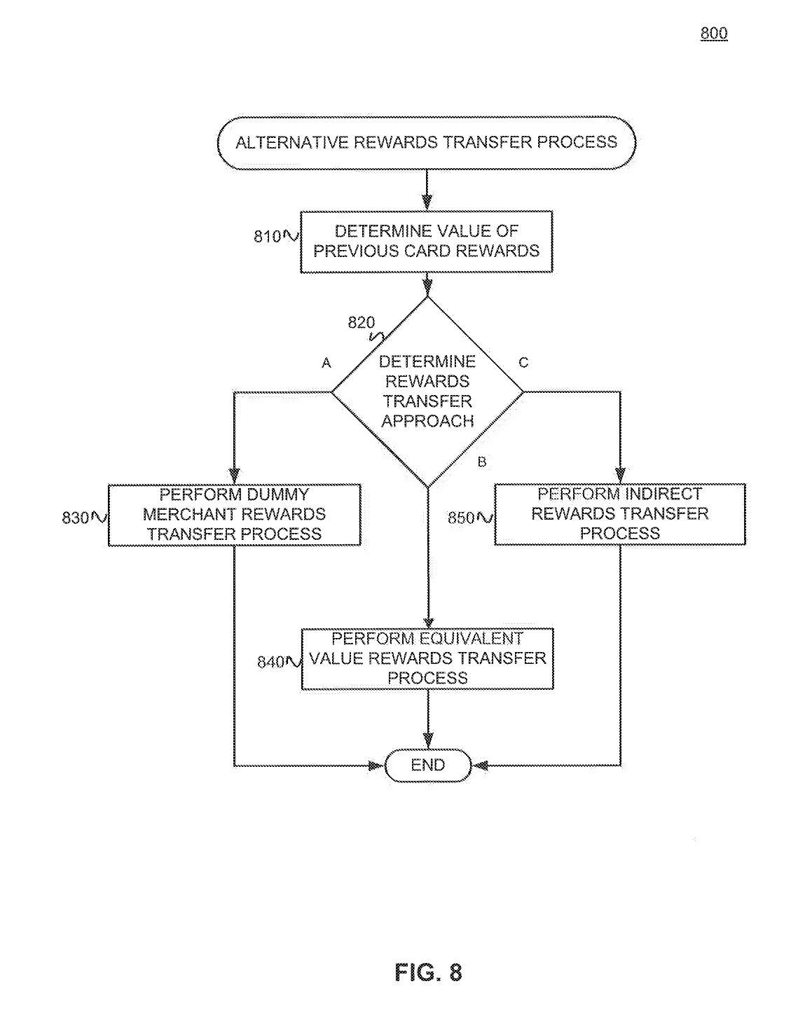

If card carrier system 130 does not possess or refuses to participate in a direct rewards transfer (Step 720: NO), card switch system 102 may perform an alternative rewards transfer process (Step 740). The alternative rewards process will now be described in association with FIG. 8.

FIG. 8 shows a flowchart of an exemplary alternative rewards transfer process 800, consistent with disclosed embodiments, and with Step 350 of credit card account switching process 300 as illustrated in FIG. 3. In certain embodiments, card switch system 102, financial service provider system 110, client devices 120, and/or card carrier system 130 may execute software instructions to perform the alternative rewards transfer process of FIG. 8. As an example, FIG. 8 is disclosed in connection with card switch system 102.

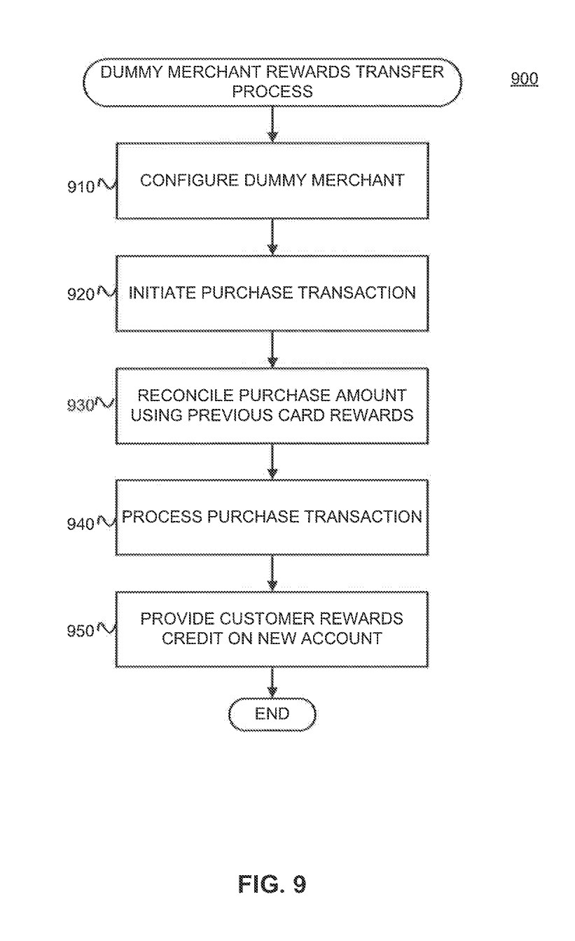

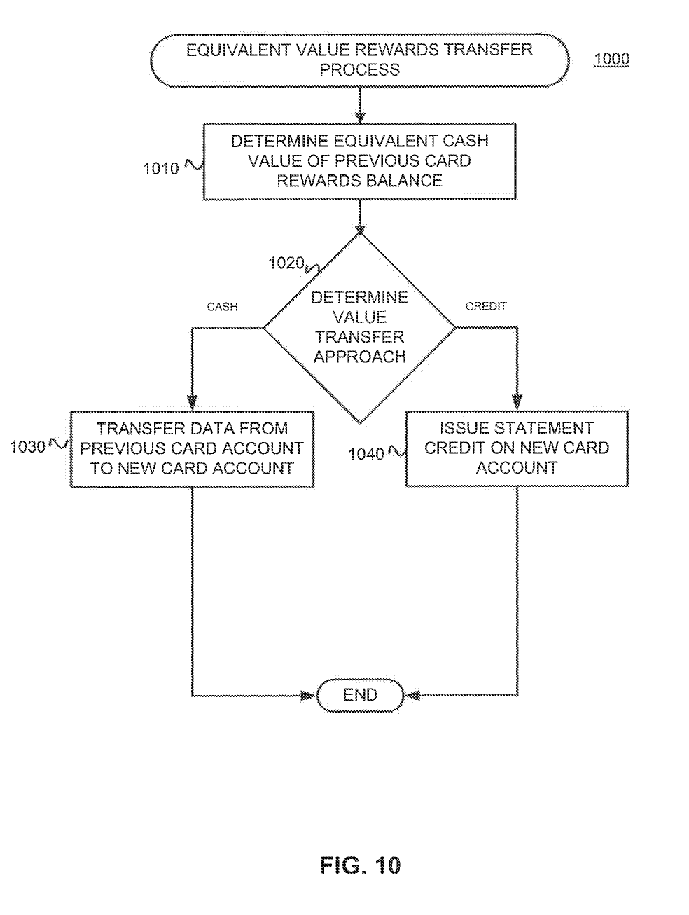

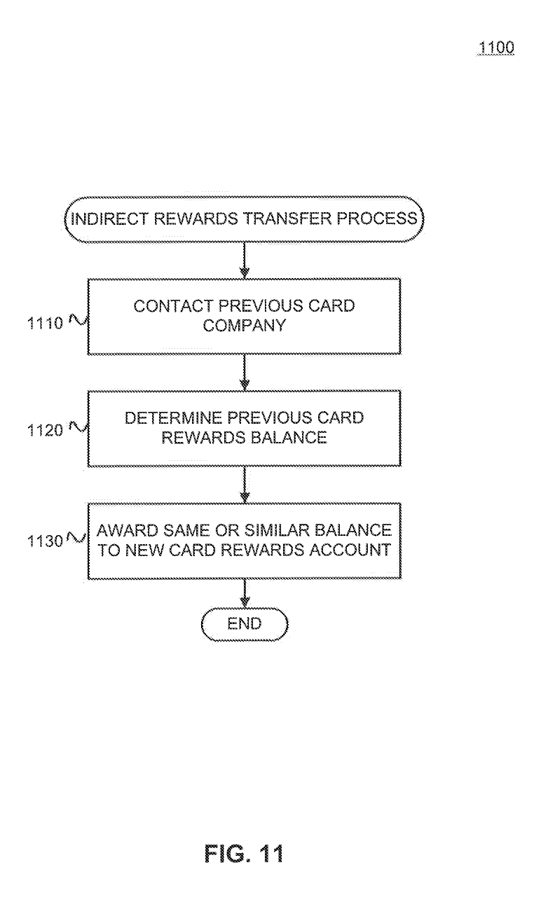

Card switch system 102 may configure switch analyzer 210 to determine the value of the rewards associated with the previous credit card account (Step 810). In alternative embodiments, parsing engine 230 and/or scraping engine 240 may also be employed to determine the value of rewards to be transferred. Based on the reward amount determination, or other predetermined criteria, switch analyzer 210 may determine which rewards transfer approach to pursue (Step 820). In some embodiments, switch analyzer 210 may determine that the proper approach is to perform a dummy merchant rewards transfer process (Step 820: A). An exemplary dummy merchant rewards transfer process (Step 830) will be described in detail below in association with FIG. 9. In alternative embodiments, switch analyzer 210 may determine that the proper approach is to perform an equivalent value rewards transfer process (Step 820: B). An exemplary equivalent value rewards transfer process (Step 840) will be described in detail below in association with FIG. 10. In yet other embodiments, switch analyzer 210 may determine that the proper approach is to perform an indirect rewards transfer process (Step 820: C). An exemplary indirect rewards transfer process (Step 850) will be described in detail below in association with FIG. 11. Switch analyzer 210 may determine the proper approach for rewards transfer based on various factors. For example, switch analyzer 210 may consider reliability and accuracy of the transfer methods, as well as cost to operate and value to the user. The proper approach may vary given the circumstances of each account switch occurrence.

FIG. 9 shows a flowchart of an exemplary dummy merchant rewards transfer process 900, consistent with disclosed embodiments, and with Step 350 of credit card account switching process 300 as illustrated in FIG. 3. In certain embodiments, card switch system 102, financial service provider system 110, client devices 120, and/or card carrier system 130 may execute software instructions to perform the dummy merchant rewards transfer process of FIG. 9. As an example, FIG. 9 is disclosed in connection with card switch system 102.

Card switch system 102 may configure a dummy merchant (Step 910). In some embodiments, the merchant may be created for the purpose of the instant rewards transfer. In other embodiments, an existing dummy merchant may be configured for purposes of the transfer. The dummy merchant may be associated with financial service provider system 110, card carrier system 130, a combination of both entities, or a third party, such as another component of system 100. Switch tool 220 may initiate a purchase transaction with the configured dummy merchant associated with the rewards transfer (Step 920). In other embodiments, card switch system 102 may send a notification to user 122 and client device 120 via network 140 providing the user with instructions for initiating the purchase transaction.

Card switch system 102 may pay, or reconcile, the purchase amount of the dummy merchant transaction with rewards associated with the previous credit card account (Step 930). In some embodiments, the previous credit card account is associated with card carrier system 130. In some embodiments, card switch system 102 may transmit a notification to card carrier system 130 directly via network 140 to inform them of the dummy merchant transaction. In some embodiments, card switch system 102 may send a notification to user 122 and client device 120 via network 140 providing the user with instructions for paying for the purchase transaction using previous card account rewards.

Card switch system 102, via switch tool 220, may process the purchase transaction (Step 940). In some embodiments, switch tool 220 may receive a notification via network 140 from card carrier system 130 confirming that the transaction took place, and/or confirming the transaction amount. In some embodiments, switch tool 220 may conduct the dummy merchant purchase transaction directly and may receive confirmation at the moment the transaction occurs. In other embodiments, the confirmation may be received at a later date. Processing may further comprise storing data relating to the dummy merchant purchase transaction in memory 208, database 227, or any other storage media associated with systems 100 and/or 200.

At Step 950, card switch system 102 may provide the user rewards credit in the previously configured rewards account associated with the new credit card account. In some embodiments, the credited rewards amount may be equal to the amount of the dummy merchant purchase transaction. In other embodiments, the credited rewards amount may be more or less than the dummy merchant purchase transaction. The amount of rewards credited in the rewards account configured for the new credit card account associated with financial service provider system 110 may vary based on predetermined criteria; for example, differences between the rewards programs of card carrier system 130 and financial service provider system 110. Reasons why the amount credited may vary from the amount in the previous account may include penalties charged by card carrier system 130, fees charged by financial service provider system 110, suspicion of fraud, caps on transferable amounts, or different values of rewards between the previous and new card carriers.

In alternative embodiments, process 900 may be carried out with an actual merchant rather than a created dummy merchant. The merchant may be associated with financial service provider system 110 or card carrier system 130, or it may be independent. For independent merchants, financial service provider system 110 may initiate a request to the merchant

FIG. 10 shows a flowchart of an exemplary equivalent value rewards transfer process 1000, consistent with disclosed embodiments, and with Step 350 of credit card account switching process 300 as illustrated in FIG. 3. In certain embodiments, card switch system 102, financial service provider system 110, client devices 120, and/or card carrier system 130 may execute software instructions to perform the equivalent value rewards transfer process of FIG. 10. As an example, FIG. 10 is disclosed in connection with card switch system 102.

Card switch system 102, via switch analyzer 210, may determine an equivalent cash or monetary value of a rewards balance associated with a previous credit card account (Step 1010). In some embodiments, the equivalent value may be equal to the previous card account rewards balance. In other embodiments, the equivalent value may be more or less than the previous card account rewards balance. The equivalent value may vary based on predetermined criteria; for example, differences between the rewards programs of card carrier system 130 and financial service provider system 110.

Card switch system 102, via switch analyzer 210, may determine a value transfer approach to pursue for purposes of awarding the user the determined equivalent value (Step 1020). The determined approach may vary based on predetermined criteria; for example, differences between the rewards programs of card carrier system 130 and financial service provider system 110, policies of card carrier system 130 and financial service provider system 110, preferences of the user, etc.

Switch analyzer 210 may determine that the proper approach is a so-called “cash” approach (Step 1020: CASH). The process proceeds to Step 1030, at which card switch system 102, via switch tool 220, may transfer data relating to the previous credit card account to the new credit card account. In some embodiments, this approach may have the benefit of keeping the rewards untouched, and populating the newly configured rewards balance to incentivize user 122 to continue spending to earn more rewards. In other embodiments, the data transferred may comprise means of directly paying out funds associated with the rewards to user 122. As a non-limiting example, card switch system 102 may send a check to user 122 via postal mail. Alternatively, card switch system 102 may provide user 122 with a coupon, debit card, voucher, or other “cash”-like payment.

In other embodiments, switch analyzer 210 may determine that the proper approach is instead a “credit” approach (Step 1020: CREDIT). The process proceeds to Step 1040, at which card switch system 102, via switch tool 220, may issue a statement credit on the new credit card account associated with user 122 in the amount of the equivalent cash value.

FIG. 11 shows a flowchart of an exemplary indirect rewards transfer process 1100, consistent with disclosed embodiments, and with Step 350 of credit card account switching process 300 as illustrated in FIG. 3. In certain embodiments, card switch system 102, financial service provider system 110, client devices 120, and/or card carrier system 130 may execute software instructions to perform the indirect rewards transfer process of FIG. 11. As an example, FIG. 11 is disclosed in connection with card switch system 102.

In Step 1110, card switch system 102, via switch analyzer 210, may initiate contact with the previous credit card carrier; for example, card carrier system 130. Switch analyzer 210 may transmit a notification via network 140, via telephonic means, via postal means, or any other known means of communication. As part of the communication with card carrier system 130, switch analyzer 210 may determine the rewards program balance associated with user 122 and a credit card account associated with card carrier system 130 (Step 1120). In some embodiments, the communication may comprise a two-way communication between switch analyzer 210 and card carrier system 130; i.e. switch analyzer 210 may transmit a message or request to card carrier system 130 and then may receive a responsive communication from card carrier system 130. Alternatively, in other embodiments switch analyzer 210 may determine the previous card's rewards balance without receiving input from card carrier system 130. In some embodiments, card switch system 102 may employ parsing engine 230 and/or scraping engine 240 to determine the previous card rewards balance. In other embodiments, card switch system 102 may determine the previous card rewards balance from user 102 directly or from client device 120.

Card switch system 102, via switch tool 220, may award a same or similar balance to the previously configured rewards account associated with the new credit card account (Step 1130). The precise amount of awarded rewards may depend on a set of predetermined criteria, such as differences in the rewards systems of financial service provider system 110 and card carrier system 130.

FIG. 12 shows a flowchart of an exemplary personal software update process 1200, consistent with disclosed embodiments, and with Step 360 of credit card account switching process 300 as illustrated in FIG. 3. In certain embodiments, card switch system 102, financial service provider system 110, client devices 120, and/or card carrier system 130 may execute software instructions to perform the personal software update process of FIG. 12. As an example. FIG. 12 is disclosed in connection with card switch system 102.

Card switch system 102 may access a personal accounting software interface associated with user 122 (Step 1210). In some embodiments, the personal accounting software may be a standalone software product stored in storage media on client device 120, in which case card switch system 102 may access client device 120 via network 140. In some embodiments, the personal accounting software may be a web applet, in which case card switch system 102 may access the interface without direct participation by user 122 or client device 120. In some embodiments, the personal accounting software may be Quicken® or Mint®.

Via switch tool 220, card switch system 102 may access an account associated with user 122 on the personal accounting software interface (Step 1220). In some embodiments, the account may be an existing account, and login credentials may have been collected during the user creditholder data step of process 300. In other embodiments, the account may be initiated or configured for the first time by switch tool 220.

At Step 1230, switch tool 220 may create a software entry associated with the new credit card account in the personal accounting software account associated with user 122. In some embodiments, the software entry may comprise a database entry. In some embodiments, the software entry may comprise a database linkage to a corresponding database entry associated with financial service provider 110; for example, memory 208 or database 227. The database linkage may be associated with an online account or interface associated with both user 122 and financial service provider 110.

Card switch system 102, by way of parsing engine 230 and scraping engine 240, may transfer data and information associated with the previous card account and/or card carrier system 130 to the software entry associated with the new credit card account (Step 1240). In some embodiments, the transfer of said information and/or data may occur within the software itself, from one configured software entry associated with the previous card account to the one newly configured for the new card account. In other embodiments, no software entry may be associated with the previous card account, and relevant information may be transferred into the accounting software by components of systems 100 and 200, such as switch analyzer 210 or scraping engine 240. In some embodiments, card switch system 102 may perform a test of the newly configured software entries by performing a test transaction or dummy transaction, such as a transfer of a few cents to the new account.

After transfer of relevant data and/or information is complete, card switch system 102 may close and/or delete any software entry or entries associated with the previous card account and/or card carrier system 130 (Step 1250). In some embodiments, the closure/deletion may occur after the new card account software entry is configured and all data and information is successfully transferred. In other embodiments, the closure/deletion may occur at a subsequent time based on a set of predetermined criteria. In other embodiments, card switch system 102 may transmit a notification to user 122 instructing them to delete the previous card account entry or entries themselves, and may transmit reminders at set time intervals relating to the closure/deletion.

Other embodiments will be apparent to those skilled in the art from consideration of the specification and practice of the disclosed embodiments. It is intended that the specification and examples be considered as exemplary only, with a true scope and spirit of the disclosed embodiments being indicated by the following claims. Furthermore, although aspects of the disclosed embodiments are described as being associated with data stored in memory and other tangible computer-readable storage mediums, one skilled in the art will appreciate that these aspects can also be stored on and executed from many types of tangible computer-readable media, such as secondary storage devices, like hard disks, floppy disks, or CD-ROM, or other forms of RAM or ROM. Accordingly, the disclosed embodiments are not limited to the above described examples, but instead is defined by the appended claims in light of their full scope of equivalents.

In addition, the disclosed embodiments may not be limited to any particular type of account or device. Additionally, instead of interaction through computer, the disclosed embodiments may be implemented through any Internet-connected device such as a smartphone, tablet, gaming console, smart device, or other mobile device, etc. Further, card switch system 102 may provide account switch processes for business entities for similar purposes. The disclosed embodiments are applicable to existing customers of account providers, and are not limited to new or potential customers. For instance, card switch system 102 may perform switch processes for existing customers of a card carrier to switch to a different card program offered by the same carrier.

What is claimed is:

1. A system for switching a previous credit card account associated with a customer to a new credit card account for the customer, comprising:
a memory storing instructions; and
one or more processors configured to execute the instructions in the memory to:
receive an indication to switch credit card accounts of the customer;
receive user cardholder data associated with at least one of the customer, the previous credit card account, or the new credit card account;
identify, based on the received cardholder data, account information associated with the previous credit card account to associate with the new credit card account; and
transfer the identified account information to a system associated with the new credit card account.

2. The system of claim 1, wherein the identified account information comprises information associated with transactions paid for with the previous credit card account for a time period preceding the transfer.

3. The system of claim 2, wherein the one or more processors are further configured to execute the instructions to:
configure a temporary account for the customer;
transfer at least one transaction paid for with the previous credit card account during the time period preceding the transfer to the configured temporary account;
determine a total amount for the at least one transferred transactions;
transmit payment in the determined total amount for the at least one transferred transactions to a system associated with the previous credit card account; and
configure a transaction on the new credit card account in the determined total amount.

4. The system of claim 1, wherein the identified account information comprises information relating to a reward or incentive program.

5. The system of claim 4, wherein the one or more processors are further configured to execute the instructions to:
determine a value of rewards or incentives previously earned by the customer associated with the previous credit card account;
determine an amount of rewards or incentives associated with the new credit card account equivalent to the determined value for the previous credit card account based on a set of predetermined criteria; and
provide the customer with the determined equivalent value amount in the form of one or more of: an amount of rewards or incentives in a rewards account configured for the new credit card account, a statement credit, or a cash payout to the customer in the determined equivalent amount.

6. The system of claim 1, wherein the identified account information comprises information relating to software entries within accounting software.

7. The system of claim 6, wherein the one or more processors are further configured to execute the instructions to:
access an account associated with the customer within an accounting software program;
generate a software entry associated with the new credit card account within the accessed customer account;
transfer information associated with the new credit card account to the generated software entry; and
remove one or more software entries within the accessed customer account associated with the previous credit card account.

8. A non-transitory computer readable medium for switching a previous credit card account associated with a customer to a new credit card account for the customer; the medium comprising instructions, which when executed by a processor cause a computer system to perform steps comprising:
receiving an indication to switch credit card accounts of the customer;
receiving user cardholder data associated with at least one of the customer, the previous credit card account, or the new credit card account;
identifying, based on the received cardholder data, account information associated with the previous credit card account to associate with the new credit card account; and
transferring the identified account information to a system associated with the new credit card account.

9. The non-transitory computer-readable medium of claim 8, wherein the received information comprises information related to merchant-initiated automatic bill payment features.

10. The non-transitory computer-readable medium of claim 8, wherein the identified account information comprises information associated with transactions paid for with the previous credit card account for a time period preceding the transfer.

11. The non-transitory computer-readable medium of claim 10, wherein the instructions, when executed by the processor, cause the computer system to perform further steps comprising:
configuring a temporary account for the customer;
transferring at least one transaction paid for with the previous credit card account during the time period preceding the transfer to the configured temporary account;
determining a total amount for the at least one transferred transactions;
transmitting payment in the determined total amount for the at least one transferred transactions to a system associated with the previous credit card account; and
configuring a transaction on the new credit card account in the determined total amount.

12. The non-transitory computer-readable medium of claim 8, wherein the identified account information comprises information relating to a reward or incentive program.

13. The non-transitory computer-readable medium of claim 12, wherein the instructions, when executed by the processor, cause the computer system to perform further steps comprising:
determining a value of rewards or incentives previously earned by the customer associated with the previous credit card account;
determining an amount of rewards or incentives associated with the new credit card account equivalent to the determined value for the previous credit card account based on a set of predetermined criteria; and
providing the customer with the determined equivalent value amount in the form of one or more of: an amount of rewards or incentives in a rewards account configured for the new credit card account, a statement credit, or a cash payout to the customer in the determined equivalent amount.

14. The non-transitory computer-readable medium of claim 8, wherein the identified account information comprises information relating to software entries within accounting software.

15. The non-transitory computer-readable medium of claim 14, wherein the instructions, when executed by the processor, cause the computer system to perform further steps comprising:
accessing an account associated with the customer within an accounting software program;
generating a software entry associated with the new credit card account within the accessed customer account;
transferring information associated with the new credit card account to the generated software entry; and
removing one or more software entries within the accessed customer account associated with the previous credit card account.

16. A system for switching a previous credit card account associated with a customer to a new credit card account for the customer, comprising:
a memory storing instructions; and
one or more processors configured to execute the instructions in the memory to:
receive an indication to switch credit card accounts of the customer;
receive a request for information associated with at least one of the customer or the previous credit card account;
compile the requested information; and
transmit the compiled information to a computer system.

17. The system of claim 16, wherein the requested information comprises information related to merchant-initiated automatic bill payment features.

18. The system of claim 16, wherein the requested information comprises information associated with transactions paid for with the previous credit card account during a time period preceding the transfer.

19. The system of claim 16, wherein the requested information comprises information relating to a reward or incentive program.

20. The system of claim 16, wherein the requested information comprises information relating to software entries within accounting software.
